(19) United States
(12) Patent Application Publication
(10) Pub. No.: US 2021/0103117 A1
(43) Pub. Date: Apr. 8, 2021

(54) BI-DIRECTIONAL COMMUNICATION OPTICAL FIBER PATCHCORD

(71) Applicant: FOCI FIBER OPTIC COMMUNICATIONS, INC., Hsinchu (TW)

(72) Inventor: Chih-Kuang Hsiao, Hsinchu City (TW)

(21) Appl. No.: 16/676,500

(22) Filed: Nov. 7, 2019

(30) Foreign Application Priority Data
Oct. 2, 2019 (TW) 108213035

(51) Int. Cl. G02B 6/44; G02B 6/293; H04B 10/25; H04J 14/02

(52) U.S. Cl. CPC G02B 6/4472; H04J 14/02; H04B 10/2503; G02B 6/2938

(57) ABSTRACT

Provided is a bi-directional communication optical fiber patchcord, including: an optical fiber connector, an optical fiber cable, and an optical connector. The optical fiber connector includes a first male optical fiber connector, a second male optical fiber connector, and a wavelength division multiplexing device. The first male optical fiber connector, the second male optical fiber connector, and the wavelength division multiplexing device are integrated into a single optical fiber connector, and the optical fiber cable is directly connected to the optical connector. The wavelength division multiplexing device may be at least one of an optical circulator, a fused optical fiber coupler, a filter wavelength division multiplexer, or a fused wavelength division multiplexer according to the users' needs. In addition, the present invention may further include an outer sheath, and thus have the characteristics of plug and play, easy to expand bandwidth, waterproof and cost-effectiveness.

### BACKGROUND OF THE INVENTION

### 1. Field of the Invention

The present invention relates to an optical fiber patchcord, in particular to a single optical fiber and a bi-directional communication optical fiber patchcord.

### 2. The Prior Arts

With the development of information society, the penetration rate of high-speed networks is increasing, and the demand for high-speed network-related devices is gradually increasing.

Optical fiber has the characteristics of low transmission loss. In the recent years, the mature optical fiber communication technology has improved the communication quality and transmission speed, and has become an important medium for the popularization of high-speed digital networks.

The so-called optical fiber communication uses optical fiber as a transmission medium to transmit information to distant places.

Traditionally, optical fiber communication uses a single carrier wavelength to transmit data. Because of the evolution of technology, current optical fiber networks can have multiple channels of different wavelengths to transmit information in one optical fiber at the same time, which is called Wavelength Division Multiplexing System.

However, the number of optical ports in a conventional wavelength division multiplexing system is a constant value, so the wavelength division multiplexing device is generally used to increase users of the optical fiber network without changing the existing optical fiber network architecture.

Traditionally, the problem with using the wavelength division multiplexing device is that the wavelength division multiplexing device and the connector are separately set, thereby causing inconvenience in construction due to too far away from each other.

At present, in the conventional optical transceiver system, the connector is directly disposed on the wavelength division multiplexing device. Although the problem of inconvenience in construction due to too far away from each other is solved, another inconvenience of cleaning the connector is derived. Once the connector is dirty or the contact is not well connected, it will cause the reflected light to interfere with the transmission of the signal.

In addition, another problem of directly disposing the connector on the wavelength division multiplexing device is that during the installation process, the connector is easily damaged and thus the stability of the transmission signal is degraded.

### SUMMARY OF THE INVENTION

The main objective of the present invention is to provide a bi-directional communication optical fiber patchcord. The optical fiber patchcord is a passive component that can be externally connected to an optical fiber cable. By using the optical fiber patchcord according to the present invention, two optical signals that are originally unidirectionally transmitted in different optical fiber cables can be bidirectionally transmitted in one optical fiber cable. In such a way, the optical fiber network that originally supports only one user can be immediately upgraded to support two users.

Another objective of the present invention is to provide an optical fiber patchcord that is easy to clean and has a stable signal transmission, while further has waterproof and dustproof function.

In order to achieve the above objectives, the present invention provides a bi-directional communication optical fiber patchcord comprising: an optical fiber connector, an optical fiber cable, and an optical connector that are sequentially connected. The optical fiber connector includes a first male optical fiber connector, a second male optical fiber connector, and a wavelength division multiplexing device. The optical fiber cable includes at least one single-core optical fiber.

According to the present invention, the wavelength division multiplexing device may be at least one of an optical circulator, a fused optical fiber coupler, a filter wavelength division multiplexer, or a fused wavelength division multiplexer according to the users' needs.

The wavelength division multiplexing device includes: a first port coupled to the first male optical fiber connector for receiving a first optical signal; and a second port coupled to the optical fiber cable for transmitting the first optical signal and receiving a second optical signal; and a third port coupled to the second male optical fiber connector for transmitting the second optical signal.

In addition, according to the present invention, one end of the optical connector is coupled to the optical fiber cable for transmitting the first optical signal and receiving the second optical signal. Moreover, the other end of the optical connector can be disposed with a specific angle to reduce the interference on the transmission of signals by the reflected light.

The optical fiber patchcord according to the present invention can further include an outer sheath for covering the optical fiber connector so as to provide waterproof and dustproof functions.

In summary, the optical fiber patchcord according to the present invention has the characteristics of plug and play, easy to expand bandwidth, waterproof, and cost-effectiveness.

In order for a person skilled in the art to understand the purpose, features and effects of the present invention, the present invention will be described in detail by the following specific embodiments and with the accompanying drawings.

### BRIEF DESCRIPTION OF THE DRAWINGS

The present invention is further described below in conjunction with the accompanying drawings and embodiments.

FIG. 1 is a schematic view of the optical fiber patchcord of the present invention;

FIG. 2a is a schematic view of the optical fiber connector of the first embodiment of the present invention;

FIG. 2b is a schematic view of the wavelength division multiplexing device of the first embodiment of the present invention;

FIG. 3a is a schematic view of the optical fiber connector of the second embodiment of the present invention;

FIG. 3b is a schematic view of the wavelength division multiplexing device of the second embodiment of the present invention;

FIG. 4 is a schematic view of the optical fiber patchcord of the third embodiment of the present invention; and

FIG. 5 is a schematic view of the optical fiber patchcord of the fourth embodiment of the present invention.

### DETAILED DESCRIPTION OF THE PREFERRED EMBODIMENT

The embodiments of the present invention will be described in more detail below with reference to the drawings and the component symbols, and the person skilled in the art can implement the present invention after studying the present specification.

However, the present invention is not limited to the embodiments disclosed herein, but will be implemented in various forms.

The following embodiments are provided by way of example only, and the person skilled in the art can fully understand the disclosure of the present invention and the scope of the present disclosure.

Therefore, the present invention is to be limited only by the scope of the appended claims.

In the drawings for describing various embodiments of the present invention, the shapes, sizes, ratios, numbers, and the like shown are merely exemplary, and the present invention is not limited thereto.

Throughout the specification, the same reference numerals generally denote the same elements.

Any reference to the singular can include the plural unless specifically stated otherwise.

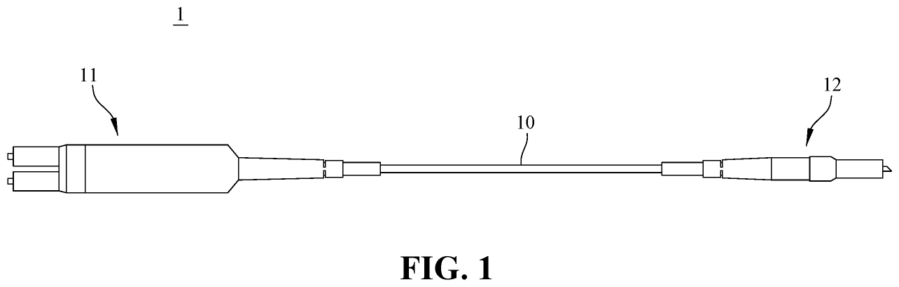

FIG. 1 is a schematic view of the optical fiber patchcord of the present invention. As shown in FIG. 1, the optical fiber patchcord 1 includes an optical fiber cable 10, an optical fiber connector 11, and an optical connector 12. The optical fiber connector 11 is disposed at one end of the optical fiber cable 10, and the optical connector 12 is disposed at the other end of the optical fiber cable 10.

In the present embodiment, the optical cable 10 has only one single-core optical fiber therein.

It should be further noted that the optical fiber cable 10 according to the present invention may include: a polyvinyl chloride (PVC) cable or a low smoke zero halogen (LSZH) cable with a central strength member, or a polyvinyl chloride (PVC) cable or a low-smoke halogen-free (LSZH) cable without a central strength member, or a bare optical fiber.

At the same time, the optical connector 12 may be a common type of optical connector (APC), such as standard connector (SC), Lucent/local connector (LC), enterprise systems connection (ESCON), ferrule connector (FC), fiber distributed data interface (FDDI), mechanical transfer (MT) or straight tip (ST) connector, but is not limited thereto in the present invention.

For example, the optical connector 12 may be coupled to a transceiver or a wavelength division multiplexing device, and an end face of the optical connector 12 coupled to the transceiver or the wavelength division multiplexing device may have a specific angle that may be greater than or equal to 0 degree and less than 90 degree with respect to a vertical direction to reduce the amount of reflection.

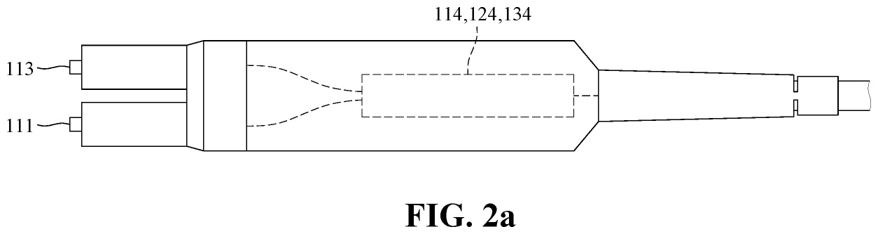

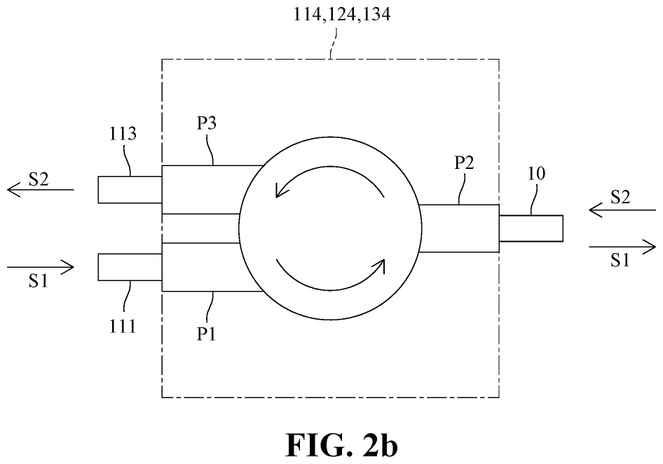

FIG. 2a is a schematic view of the optical fiber connector of the first embodiment of the present invention. FIG. 2b is a schematic view of the wavelength division multiplexing device in the embodiment of FIG. 2a.

As shown in FIG. 2a, the optical fiber connector 11 may include a first male optical fiber connector 111, a second male optical fiber connector 113, and a wavelength division multiplexing device 114.

In this embodiment, the wavelength division multiplexing device 114 is an optical circulator 124 or a fused optical fiber coupler 134.

Referring to FIG. 2b, both the optical circulator 124 and the fused optical fiber coupler 134 have three ports, which are a first port P1, a second port P2, and a third port P3.

The first port P1 is coupled to the first male optical fiber connector 111, the second port P2 is coupled to the optical fiber cable 10, and the third port P3 is coupled to the second male optical fiber connector 113.

In the optical circulator 124 and the fused optical fiber coupler 134, the first port P1 has unidirectional input function, the second port P2 has bidirectional input/output function, and the third port P3 has unidirectional output function.

Specifically, the first port P1 is used to receive (or input) a first optical signal S1. For example, the first port P1, which may be coupled to a transmitting end of a terminal device of the user, receives the first optical signal S1 from the transmitting end of the terminal device of the user.

The second port P2 is coupled to the optical fiber cable 10, which is connected to the optical connector 12, for transmitting the first optical signal S1 and receiving a second optical signal S2. For example, the optical connector 12 may be coupled to a transceiver or a wavelength division multiplexing device, and the second port P2 may transmit the first optical signal S1 to the transceiver or the wavelength division multiplexing device through the optical fiber cable 10, and receive the second optical signal S2 from the transceiver or the wavelength division multiplexing device through the optical fiber cable 10.

The third port P3 is used to transmit (or output) the second optical signal S2. For example, the third port P3 may be coupled to a receiving end of the terminal device of the user, and transmit the second optical signal S2 to the receiving end of the terminal device of the user.

In this embodiment, when the wavelength division multiplexing device 114 is the optical circulator 124 or the fused optical fiber coupler 134, the first optical signal S1 and the second optical signal S2 have the same wavelength, which effectively simplifies the use of wavelength sorting, and solves the complexity of planning wavelength of the wavelength division multiplexing system, and the disadvantage of not easy to manage.

At the same time, the bi-directional communication of the single-core optical fiber can be successfully realized by the above-mentioned wavelength division multiplexing device 114, and thus the communication capacity is doubled.

In this embodiment, the first male optical fiber connector 111 and the second male optical fiber connector 113 are disposed in parallel with each other on one side of the wavelength division multiplexing device 114.

However, the present invention is not limited thereto.

It should be further noted that the difference between the optical circulator 124 and the fused optical fiber coupler 134 is that when the wavelength division multiplexing device 114 is the optical circulator 124, the optical fiber patchcord 1 has a lower optical loss of between about 0.7 dB and 1.5 dB, but has a higher cost compared with the fused optical fiber coupler 134. Conversely, when the wavelength division multiplexing device 114 is the fused optical fiber coupler 134, it has a lower cost, but has a higher optical loss of between about 3.4 dB and 4.2 dB.

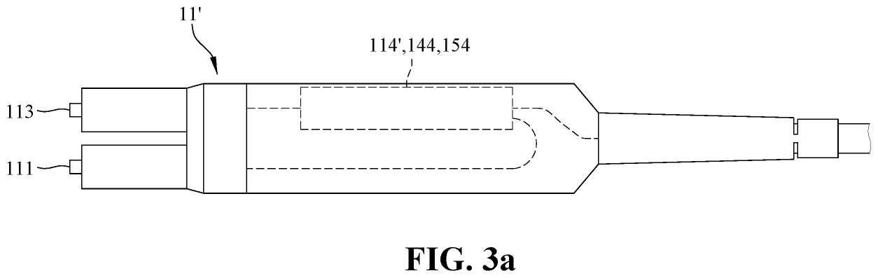

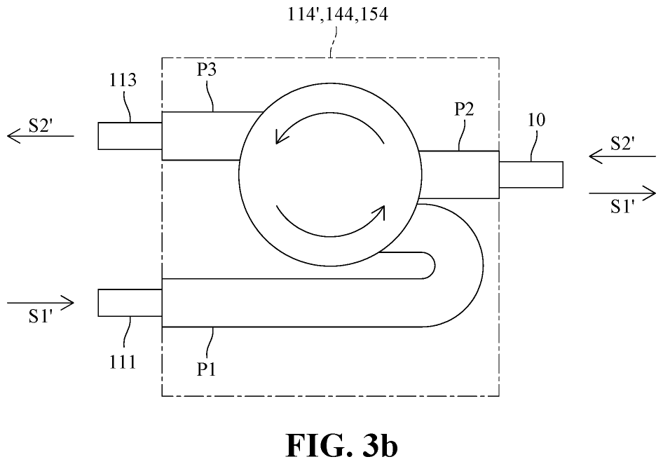

FIG. 3a is a schematic view of the optical fiber connector of the second embodiment of the present invention; and FIG. 3b is a schematic view of the wavelength division multiplexing device according to the embodiment of FIG. 3a. The main improvement of this embodiment is to use a different wavelength division multiplexing device 114′. Compared to the first embodiment, the present embodiment has better channel wavelength flatness such that the optical loss is lowered.

As shown in FIG. 3a, the optical fiber connector 11′ may include the first male optical fiber connector 111, the second male optical fiber connector 113, and the wavelength division multiplexing device 114′.

In this embodiment, the wavelength division multiplexing device 114′ is a filter wavelength division multiplexer 144 or a fused wavelength division multiplexer 154.

Referring to FIG. 3b, both the filter wavelength division multiplexer 144 and the fused wavelength division multiplexer 154 have three ports, which are the first port P1, the second port P2, and the third port P3.

The first port P1 is coupled to the first male optical fiber connector 111, the second port P2 is coupled to the optical fiber cable 10, and the third port P3 is coupled to the second male optical fiber connector 113.

In the filter wavelength division multiplexer 144 and the fused wavelength division multiplexer 154, the first port P1 has unidirectional input function, the second port P2 has bidirectional input/output function, and the third port P3 has unidirectional output function.

Specifically, the first port P1 is used to receive (or input) a first optical signal S1′. For example, the first port P1 may be coupled to a transmitting end of a terminal device of the user, and receive the first optical signal S1′ from the transmitting end of the terminal device of the user. The second port P2 is coupled to the optical fiber cable 10, which is connected to the optical connector 12, for transmitting the first optical signal S1′ and receiving a second optical signal S2′. For example, the optical connector 12 may be coupled to a transceiver or a wavelength division multiplexing device, and the second port P2 may transmit the first optical signal S1′ to the transceiver or the wavelength division multiplexing device through the optical fiber cable 10, and receive the second optical signal S2′ from the transceiver or the wavelength division multiplexing device through the optical fiber cable 10. The third port P3 is used to transmit (or output) the second optical signal S2′. For example, the third port P3 may be coupled to a receiving end of the terminal device of the user, and transmit the second optical signal S2′ to the receiving end of the terminal device of the user.

In this embodiment, when the wavelength division multiplexing device 114′ is the filter wavelength division multiplexer 144 or the fused wavelength division multiplexer 154, the first optical signal S1′ and the second optical signal S2′ have different wavelengths. Compared with the filter wavelength division multiplexer 114 of the first embodiment, the present embodiment has better channel wavelength flatness, so that the optical loss is lowered, but the disadvantage thereof is that the wavelength planning of the wavelength division multiplexing system is complicated.

The bi-directional communication of the single-core optical fiber can be successfully realized by the above-described wavelength division multiplexing device 114′, and thus the communication capacity is doubled.

It should be further noted that the difference between the filter wavelength division multiplexer 144 and the fused wavelength multiplexer 154 is that when the wavelength division multiplexing device 114′ is the filter wavelength division multiplexer 144, the optical fiber patchcord 1 has a lower optical loss of between about 0.3 dB and 0.5 dB, but has a higher cost compared with the fused wavelength division multiplexer 154. Conversely, when the wavelength division multiplexing device 114 is the fused optical fiber coupler 134, it has a lower cost, but has a higher optical loss of between about 0.5 dB and 1.0 dB.

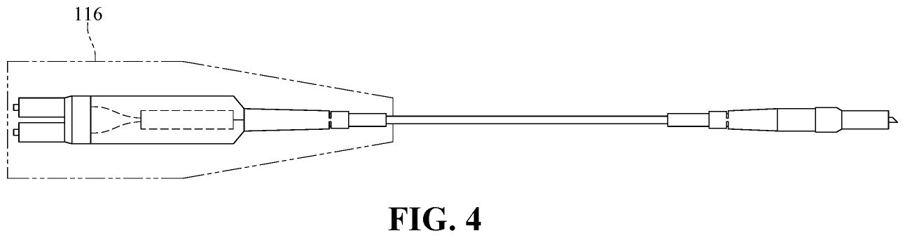

FIG. 4 is a schematic view of the optical fiber patchcord of the third embodiment of the present invention. As shown in FIG. 4, the optical fiber patchcord 1 according to the present invention further includes an outer sheath 16 for covering a periphery of the optical fiber connector 11.

The outer sheath 16 may be made of various materials with dustproof or waterproof functions, such as polyvinyl chloride (PVC), or low-smoke halogen-free (LSZH).

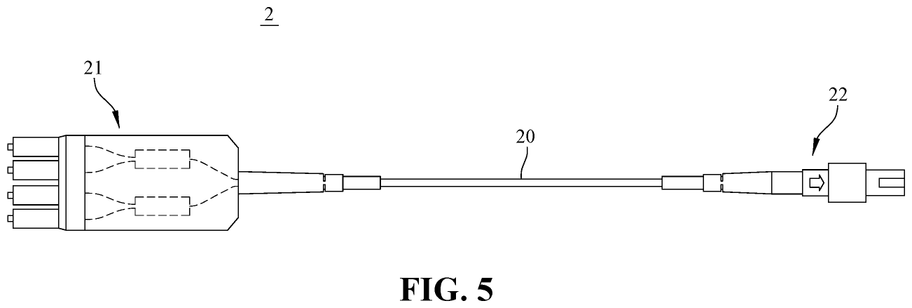

FIG. 5 is a schematic view of the optical fiber patchcord of the fourth embodiment of the present invention. As shown in FIG. 5, the optical fiber patchcord 2 includes: an optical fiber cable 20, an optical fiber connector 21, and an optical connector 22. The optical fiber connector 21 is disposed at one end of the optical cable 20, and the optical connector 22 is disposed at the other end of the optical cable 20.

In this embodiment, the optical fiber cable 20 has a plurality of optical fibers therein, and the optical fiber connector 21 includes a plurality of male optical fiber connectors and a plurality of wavelength division multiplexing devices.

The number of the male optical fiber connectors is twice that of the optical fibers in the optical fiber cable 20, thereby effectively reducing the quantity of the optical fibers used.

For example, the optical connector 22 may be a multi-core optical connector coupled to a plurality of transceivers or a plurality of wavelength division multiplexing devices. The end face of the optical connector 22 coupled to the transceivers or the wavelength division multiplexing devices may have a specific angle that may be greater than or equal to 0 degree and less than 90 degree with respect to a vertical direction to reduce the amount of reflection.

In this way, the present invention has the following implementation effects and technical effects.

First, the optical connector 12 and the wavelength division multiplexing device 114 are separated by the optical fiber cable 10 in the present invention, thereby effectively reducing the risk of damage of the optical fiber patch cord 1 of the present invention during installation, while solving the inconvenience in cleaning the connector of the conventional optical transceiver system.

Second, the present invention effectively reduces the interference on the transmission of signals by the reflected light by disposing one end surface of the optical connector 12 with an angle.

Third, the present invention solves the limitation on the number of wavelength channels of the wavelength division multiplexing system through the wavelength division multiplexing device 114 inside the optical fiber connector 11, and can increase to double of the number of the original wavelength channels without newly installing the optical fibers.

Fourth, the users may select the appropriate wavelength division multiplexing device 114 according to the desires, so as to achieve the most cost-effective choice.

Fifth, the optical fiber connector 11 is covered by the outer sheath 16 so that the optical fiber patchcord of the present invention has the functions of waterproof, dustproof, and sun-resistance, especially used outdoors.

The above description is only for explaining the preferred embodiments of the present invention, and is not intended to limit the present invention. Therefore, any form of the changes should be included in the scope of the invention as claimed.

The embodiments of the present invention are described above by way of specific embodiments, and a skilled person in the art can easily understand other advantages and functions of the present invention by the contents disclosed in the present specification.

What is claimed is:

1. A bi-directional communication optical fiber patchcord, comprising:
an optical fiber cable having a single-core optical fiber therein;
an optical fiber connector disposed at one end of the optical fiber cable and comprising a first male optical fiber connector, a second male optical fiber connector, and a wavelength division multiplexing device; and
an optical connector disposed at another end of the optical fiber cable.

2. The bi-directional communication optical fiber patchcord of claim 1, wherein the wavelength division multiplexing device includes:
a first port coupled to the first male optical fiber connector for receiving a first optical signal;
a second port coupled to the optical fiber cable for transmitting the first optical signal and receiving a second optical signal; and
a third port coupled to the second male optical fiber connector for transmitting the second optical signal.

3. The bi-directional communication optical fiber patchcord of claim 2, wherein the wavelength division multiplexing device is an optical circulator, or a fused optical fiber coupler.

4. The bi-directional communication optical fiber patchcord of claim 2, wherein the first optical signal has a first wavelength, and the second optical signal has a second wavelength, and the first wavelength is the same as the second wavelength.

5. The bi-directional communication optical fiber patchcord of claim 2, wherein the wavelength division multiplexing device is a filter wavelength division multiplexer, or a fused wavelength division multiplexer.

6. The bi-directional communication optical fiber patchcord of claim 2, wherein the first optical signal has a first wavelength, and the second optical signal has a second wavelength, and the first wavelength is different from the second wavelength.

7. The bi-directional communication optical fiber patchcord of claim 1, wherein one end surface of the optical connector is disposed with an angle that is greater than or equal to 0 degree and less than 90 degree with respect to a vertical direction.

8. The bi-directional communication optical fiber patchcord of claim 1, further comprising an outer sheath for covering the optical fiber connector.

9. A bi-directional communication optical fiber patchcord, comprising:
an optical fiber cable having a plurality of optical fibers therein;
an optical fiber connector disposed at an end of the optical fiber cable and comprising a plurality of male optical fiber connectors and a plurality of wavelength division multiplexing devices; and
a multi-core optical connector disposed at another end of the optical fiber cable, wherein one end surface of the optical connector is disposed with an angle.

10. The bi-directional communication optical fiber patchcord of claim 9, wherein the number of the male optical fiber connectors is twice that of the optical fibers in the optical fiber cable.
